(19) United States
(12) Patent Application Publication
(10) Pub. No.: US 2018/0343191 A1
(43) Pub. Date: Nov. 29, 2018

(54) HOP CONSTRAINED WIDEST PATH FOR SEGMENT ROUTING

(71) Applicants: Fang HAO, Morganville, NJ (US); Murali KODIALAM, Marlboro, NJ (US); T.V. LAKSHMAN, Marlboro, NJ (US)

(72) Inventors: Fang HAO, Morganville, NJ (US); Murali KODIALAM, Marlboro, NJ (US); T.V. LAKSHMAN, Marlboro, NJ (US)

(21) Appl. No.: 15/605,773

(22) Filed: May 25, 2017

(51) Int. Cl. H04L 12/721; H04L 12/733

(52) U.S. Cl. CPC H04L 45/123; H04L 45/20

(57) ABSTRACT

A method of determining a maximum flow network path between a source node and a destination node using segment routing when constrained by a maximum number of hops, the method including establishing a segment graph, calculating the bandwidth capacity of each link in the segment graph, calculating the multiplicity for each link in the segment graph, initializing a predecessor array indicating the predecessor node for each node and hop value, for each link in the segment graph and for each hop value up to the maximum number of hops: determining the maximum bandwidth path to the end of each segment and the associated number of hops based upon the bandwidth capacity, and updating a value of the predecessor array when the maximum bandwidth path to the end of segment is determined, and determining the maximum flow network path based upon the predecessor array.

### TECHNICAL FIELD

Embodiments described herein include segment routing in high performance telecommunications networks.

### BACKGROUND

A fundamental operation in networks is routing packets from source to destination. In internet protocol (IP) networks, routing may be done along shortest paths by a routing protocol like open shortest path first (OSPF) or intermediate system to intermediate system (IS-IS). These shortest path based routing protocols ensure loop-free delivery of packets. When using shortest path routing, all traffic between a given source (S) and destination (D) is routed on the shortest path between the source and destination. If the traffic is greater than expected, it is not possible to shift this traffic along alternate paths even if spare bandwidth is available elsewhere in the network. This is one of the major drawbacks of shortest path routing. Increasingly traffic has to be routed through middle boxes like load balancers and firewalls. Also, it is not possible to exert fine grained control on the paths if shortest path routing is used.

### SUMMARY

A brief summary of various embodiments is presented below. Some simplifications and omissions may be made in the following summary, which is intended to highlight and introduce some aspects of the various embodiments, but not to limit the scope of the invention. Detailed descriptions of embodiments adequate to allow those of ordinary skill in the art to make and use the inventive concepts will follow in later sections.

Various embodiments relate to a method of determining a maximum flow network path between a source node and a destination node using segment routing when constrained by a maximum number of hops, the method including establishing a segment graph, calculating the bandwidth capacity of each link in the segment graph, calculating the multiplicity for each link in the segment graph, initializing a predecessor array indicating the predecessor node for each node and hop value, for each link in the segment graph and for each hop value up to the maximum number of hops: determining the maximum bandwidth path to the end of each segment and the associated number of hops based upon the bandwidth capacity, updating a value of the predecessor array when the maximum bandwidth path to the end of segment is determined, and determining the maximum flow network path based upon the predecessor array.

The method may include updating the value of the predecessor array includes choosing the path with the fewest links when two different paths to the end of the segment have the same maximum bandwidth.

The maximum bandwidth value D1(v,j) for each value of j may be initialized to D1(v,j−1), where v is an index indicating nodes in the network and j is an index indicating a hop value from 1 to h, where h is the maximum hop value.

The number of links value D2(v,j) for each value of j may be initialized to D2(v,j−1), where v is an index indicating nodes in the network and j is an index indicating a hop value from 1 to h, where h is the maximum hop value.

Determining the maximum bandwidth path to the end of each segment and the associated number of hops may include determining when min {D₁(u,j−1),c̅(q)}≥D₁(u,j), where D1(u,j) is a maximum bandwidth value, u is an index indicating the node at the beginning of a link q, j is an index indicating a hop value from 1 to h, h is the maximum hop value, q indicates a link between two nodes, and c̅(q) is the bandwidth capacity bandwidth of the link q.

The method may include setting D1(v,j)=min {D₁(u,j−1),c̅(q)}, setting D2(v,j)=D2(u,j−1)+μ(q), and setting PRED(v,j)=u, when min {D₁(u,j−1),c̅(q))}>D₁(u,j), where v is an index indicating the node at the end of a link q, μ(q) is the multiplicity of link q, and PRED(v,j) is the predecessor array.

The method may include setting D2(v,j)=D2(u,j−1)+μ(q) and setting PRED(v,j)=u, when min {D₁(u,j−1),c̅(q)}=D₁(u,j) and D2(v,j)<D2(u,j−1)+μ(q), where v is an index indicating the node at the end of a link q, μ(q) is the multiplicity of link q, and PRED(v,j) is the predecessor array.

The method may include setting D1(v,j)=min {D(u,j−1),c̅(q)}, setting D2(v,j)=D2(u,j−1)+μ(q), and setting PRED(v,j)=u, when min {D₁(u,j−1),c̅(q))}>D(u,j), and setting D2(v,j)=D2(u,j−1)+μ(q) and setting PRED(v,j)=u, when min {D₁(u,j−1),c̅(q)}=D₁(u,j) and D2(v,j)<D2(u,j−1)+μ(q), where v is an index indicating the node at the end of a link q, μ(q) is the multiplicity of link q, and PRED(v,j) is the predecessor array.

Various embodiments also relate to a non-transitory computer readable medium including program instructions for causing a computer processor to perform a method of determining a maximum flow network path between a source node and a destination node using segment routing when constrained by a maximum number of hops, the machine-readable storage medium including instructions for establishing a segment graph, instructions for calculating the bandwidth capacity of each link in the segment graph, instructions for calculating the multiplicity for each link in the segment graph, instructions for initializing a predecessor array indicating the predecessor node for each node and hop value, instructions for each link in the segment graph and for each hop value up to the maximum number of hops: instructions for determining the maximum bandwidth path to the end of each segment and the associated number of hops based upon the bandwidth capacity, instructions for updating a value of the predecessor array when the maximum bandwidth path to the end of segment is determined, and instructions for determining the maximum flow network path based upon the predecessor array.

Embodiments may include a non-transitory machine-readable storage medium, wherein updating the value of the predecessor array may include choosing the path with the fewest links when two different paths to the end of the segment have the same maximum bandwidth.

Embodiments may include a non-transitory machine-readable storage medium, wherein the maximum bandwidth value D1(v,j) for each value of j may be initialized to D1(v,j−1), where v is an index indicating nodes in the network and j is an index indicating a hop value from 1 to h, where h is the maximum hop value.

Embodiments may include a non-transitory machine-readable storage medium, wherein the number of links value D2(v,j) for each value of j may be initialized to D2(v,j−1), where v is an index indicating nodes in the network and j is an index indicating a hop value from 1 to h, where h is the maximum hop value.

Embodiments may include a non-transitory machine-readable storage medium, wherein determining the maximum bandwidth path to the end of each segment and the associated number of hops may include determining when min {D₁(u,j−1),c̅(q)}≥D₁(u,j), where D1(u,j) is a maximum bandwidth value, u is an index indicating the node at the beginning of a link q, j is an index indicating a hop value from 1 to h, h is the maximum hop value, q indicates a link between two nodes, and c̅(q) is the bandwidth capacity bandwidth of the link q.

Embodiments may include a non-transitory machine-readable storage medium, further including instructions for setting D1(v,j)=min {D₁(u,j−1),c̅(q)}, setting D2(v,j)=D2(u,j−1)+μ(q), and setting PRED(v,j)=u, when min {D₁(u,j−1),c̅(q))}>D₁(u,j), where v is an index indicating the node at the end of a link q, μ(q) is the multiplicity of link q, and PRED(v,j) is the predecessor array.

Embodiments may include a non-transitory machine-readable storage medium, further including instructions for setting D2(v,j)=D2(u,j−1)+μ(q) and setting PRED(v,j)=u, when min {D₁(u,j−1),c̅(q))=D₁(u,j) and D2(v,j)<D2(u,j−1)+μ(q), where v is an index indicating the node at the end of a link q, μ(q) is the multiplicity of link q, and PRED(v,j) is the predecessor array.

Embodiments may include a non-transitory machine-readable storage medium, further including instructions for setting D1(v,j)=min {D₁(u,j−1),c̅(q)}, instructions for setting D2(v,j)=D2(u,j−1)+μ(q), and setting PRED(v,j)=u, when min{D(u,j−1),c̅(q)}>D₁(u,j), and instructions for setting D2(v,j)=D2(u,j−1)+μ(q) and instructions for setting PRED(v,j)=u, when min {D₁(u,j−1),c̅(q)}=D₁(u,j) and D2(v,j)<D2(u,j−1)+μ(q), where v is an index indicating the node at the end of a link q, μ(q) is the multiplicity of link q, and PRED(v,j) is the predecessor array.

### BRIEF DESCRIPTION OF THE DRAWINGS

Additional objects and features of the invention will be more readily apparent from the following detailed description and appended claims when taken in conjunction with the drawings. Although several embodiments are illustrated and described, like reference numerals identify like parts in each of the figures, in which:

FIGS. 1A-1C illustrate routing connections and flow in accordance with embodiments described herein;

FIGS. 2A-2D illustrate physical and segment cover typologies in accordance with embodiments described herein;

FIG. 3 illustrates a variant of Dijkstra's algorithm in accordance with embodiments described herein;

FIGS. 4A-4D illustrate a hop constrained widest path in accordance with embodiments described herein; and

FIG. 5 illustrates an algorithm for the minimum multiplicity widest path.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated. Descriptors such as “first,” “second,” “third,” etc., are not meant to limit the order of elements discussed, are used to distinguish one element from the next, and are generally interchangeable.

Segment routing provides a flexible routing mechanism in internet protocol multi-protocol label switching (IP-MPLS) networks. A price that is paid for flexibility in segment routing is overhead incurred in specifying the segment end-points in a packet header. Because a MPLS label handling mechanism may be used to process the segment routing header at the nodes, there are typically practical restrictions on the label stack depth. This constraint on the label stack depth is equivalent to restricting the number of segments in any path on which traffic is routed.

According to embodiments described herein a distinction may be made between routing a connection and routing flows. When a connection is routed in a network, all packets belonging to this connection will take the same path between its end points. This is done such that packets arrive to a destination in the same sequence in which they were transmitted. Therefore in a connection routing problem an objective is to determine a single path between connection endpoints that have sufficient bandwidth to carry the connection. Flows may be defined as an aggregation of connections. When routing a flow, there is no restriction to finding a single path for the flow. Instead, a set of paths may be found between the flow end points such that the sum of the bandwidth along these paths equals the total bandwidth for the flow.

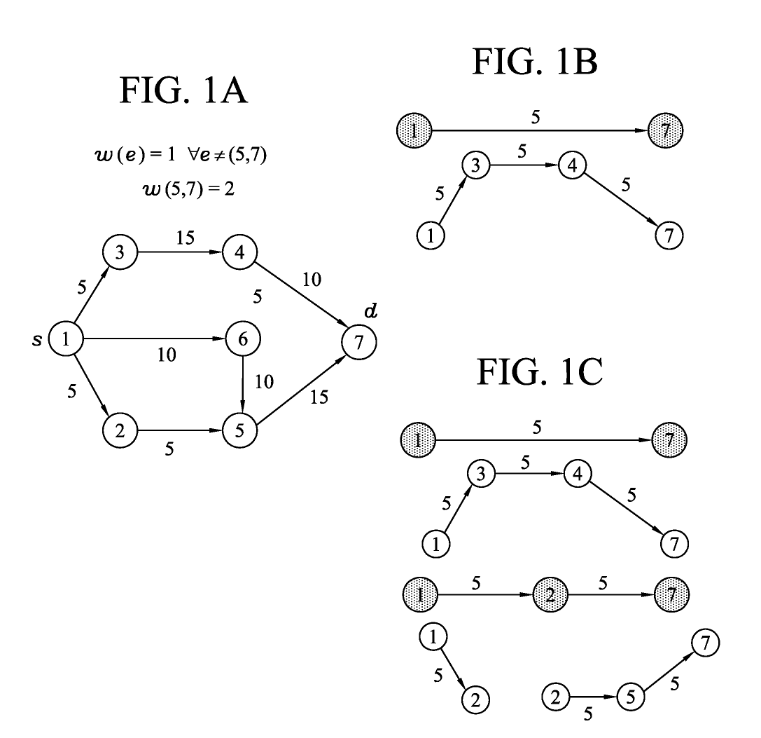

FIGS. 1A-1C illustrate routing connections and flow in accordance with embodiments described herein. In FIG. 1A, the physical topology is illustrated with the link capacities shown next to the link. The link weight w(e)=1 for all links except link (5,7) that has a weight of 2. One goal is to route connections and flows between source node 1 and destination node 7.

A hop is one portion of the path between source and destination. Data packets pass through bridges, routers and gateways as they travel between source and destination. Each time packets are passed to the next network device, a hop occurs. A hop count refers to the number of intermediate devices such as routers through which data must pass between source and destination, rather than flowing over a single wire.

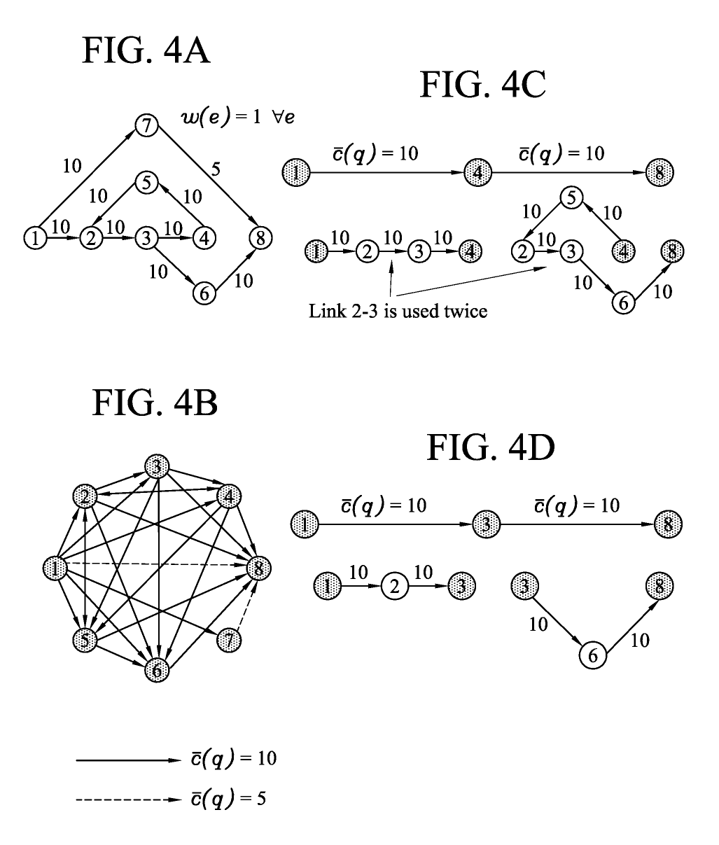

As illustrated in FIG. 1B, a hop limit h=2 is illustrated in a 2-hop connection and in a 2-hop flow. A connection with bandwidth 5 is illustrated in FIG. 1C. This includes one segment (1,7) in the segment graph (illustrated in FIG. 4) which may correspond to a path in the physical topology of 1-3-4-7 with a summed weight of 3. The bottom right of the figure demonstrates a flow of 10 units between nodes 1 and 7. Note that the flow is on two different paths in the segment graph. Typical network planning problems where the objective is to determine if there is sufficient bandwidth in the network to carry a specified amount of traffic between different source destination pairs are flow routing problems. Both for connection and flow problems, the routing paths have to satisfy the hop restrictions imposed by segment routing. Connection routing problems are described herein. One connection routing problem discussed is the Hop Constrained Widest Path Problem. Given the physical topology and a source destination pair, an objective of the hop constrained widest path problem is to determine the maximum bandwidth connection that can be routed between the source destination pair. Because it is a connection routing problem, a single path between the source and the destination may be determined.

Various notations are used herein. A network G=(N,E) may be given where the nodes are the routers connected by directed links. Link e has an Internet Gateway Protocol (IGP) link weight w(e) and capacity c(e). The network uses segment routing and the label stack depth is restricted to be at most h. Therefore any path from source to destination can have at most h segments. Note that when there are multiple shortest paths between nodes, the network can split traffic across these equal cost paths (ECMP). The set SP(u,v) includes of all links that belong in any shortest path. F_{w}(e) denotes the fraction of flow on link e when one unit of flow is sent from u to v. In order to explicitly model the segments, the segment graph GS of the given network G may be constructed. The segment graph is an overlay network on the physical topology G. Corresponding to link q=(u,v) in the segment graph is the set of all links in the set SP(u,v). The set of links may be denoted in the underlying graph corresponding to link q in the segment graph by SP(q).

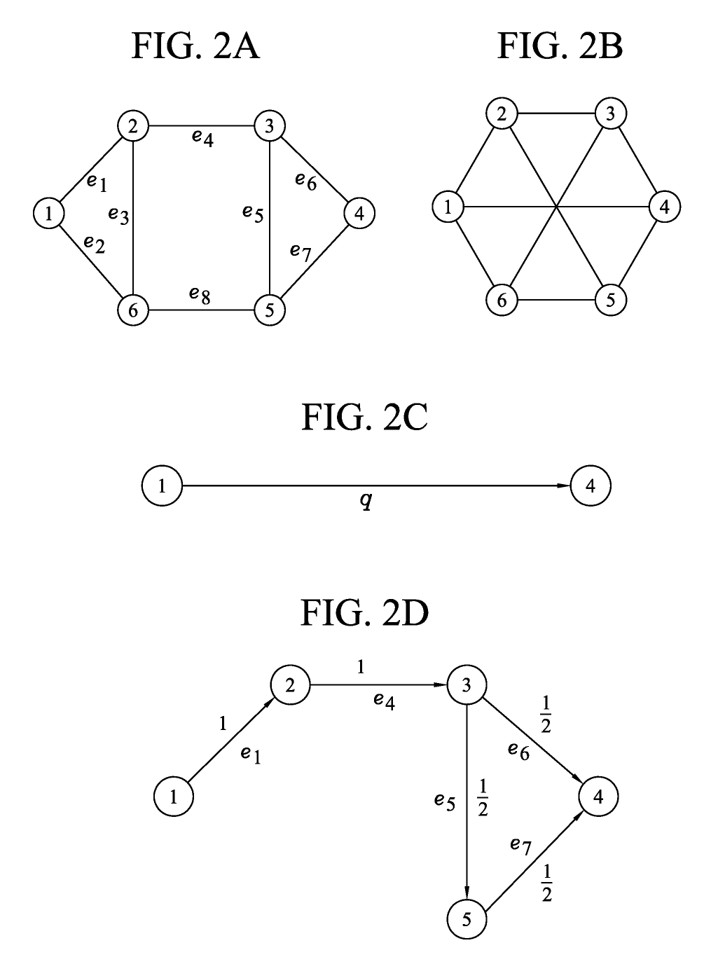

FIGS. 2A-2D illustrate physical and segment cover typologies in accordance with embodiments described herein. FIG. 2A illustrates the physical topology, FIG. 2B illustrates a segment graph and FIG. 2C illustrates links in the physical topology corresponding to link q=(1,4) in the segment graph. Given a segment q=(u,v), F_{q}(e)=F_{w}(e) may be used as a shorthand to represent the fraction of flow on link e when one unit of flow is sent on segment q. FIG. 2D illustrates the values of F_{q}(e) for all links e for segment q=(1,4) and a corresponding shortest path SP(q) in the physical typology. The number next to link e is fq(e).

Regarding hop constrained widest path, one question that may arise when routing connections between given source and destination nodes is determining the highest bandwidth connection that can be routed between the source and destination. Before addressing the question of finding the widest path in segment networks, the algorithm to find the widest path in graph is reviewed.

A widest path in a graph is described herein. A directed graph may have capacity c(e) on link e, a source node s and destination node d. For any path P between s and d, width Ω(P) of the path P to be the minimum capacity link on the path is defined as:

$$Ω ( P ) = {min}_{e ∈ P} c ( e ) .$$

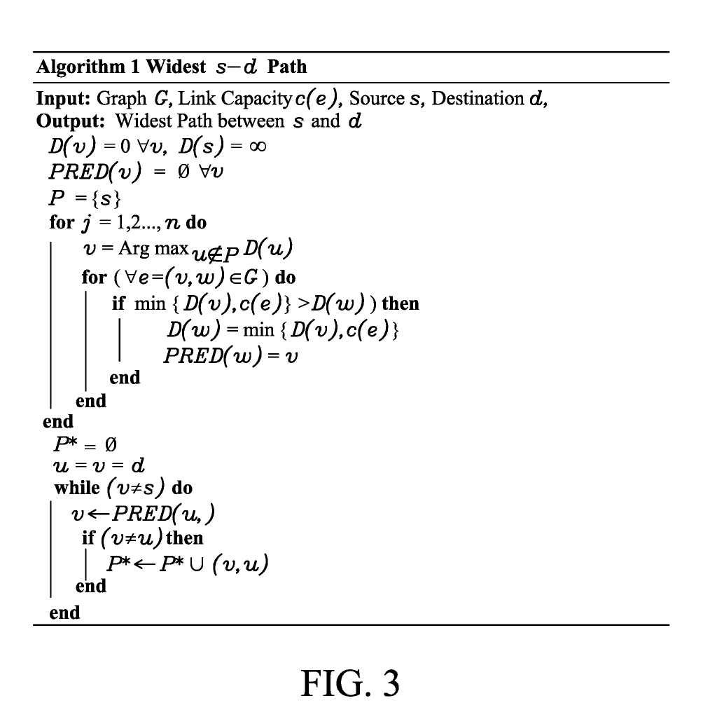

FIG. 3 illustrates a variant of Dijkstra's algorithm in accordance with embodiments described herein. One goal is determine the s−d path with the maximum width. A widest (s,d) path can be computed using the variant of Dijkstra's algorithm. Initially all nodes except the source get a label of 0 and the source gets a label of infinity. The only permanently labeled node is s. At each step of the algorithm, the algorithm picks the non-permanently labeled node v with the largest label and considers all links of the form e=(v,w). The label D(w) of node w is set to the maximum of the current label and the minimum of D(v) and c(e). This is in contrast to Dijkstra's algorithm where in each step the minimum non-permanently labeled node is selected and the label of the node is updated to the minimum of the current label and the sum of D(v)+c(e). A running time of the widest path algorithm is the same as Dijkstra's algorithm. In the description of the algorithm P* is the widest path between s and d.

A hop constrained widest path for segment routing according to embodiments described herein will be described. The algorithm in FIG. 3 that computes the widest path in graphs cannot be used directly to find the widest path in a segment routed network due to several reasons.

Each link in the segment graph corresponds to the shortest path (or shortest path directed to a cyclic graph in the case of ECMP) in the physical topology. Therefore the capacity of a link in the segment graph may be computed based on the capacity of the links in the shortest path in the physical topology.

A path in the segment graph may traverse a link in the physical topology more than once. This fact may be taken into consideration when computing the capacity of a link in the segment graph.

The algorithm ignores the hop limit and therefore may be modified to include the constraint that the number of hops in the segment graph cannot exceed h.

Consider a link q in the segment graph. If the ECMP is not enabled, then SP(q) represents the unique shortest path that will be used to route traffic between the nodes a(q) and b(q). In this case, the capacity of link q in the segment graph is the minimum capacity link belonging to SP(q) the physical topology. If ECMP is enabled, then traffic can be split on multiple paths between a(q) and b(q). The exact path taken by a connection will depend on a hash computed on the packet header belonging to the connection. Therefore, a lower limit on the minimum connection bandwidth when link q in the segment graph is used is ē(q)=min_{e∈SP(q)}c(e). We can use c̅(q) as the capacity of link q and use the widest path algorithm on the segment graph. If a path traverses an arc in the physical topology multiple times, then the capacity of the link in the segment graph may account for this fact. For example, consider the physical topology and the corresponding segment graph illustrated in FIG. 4.

FIGS. 4A-4D illustrates a hop constrained widest path in accordance with embodiments described herein. As illustrated in FIG. 4A, consider the path in the segment graph from node 1 to node 8 including the links (1,4),(4,8). The path and the corresponding links in the physical topology traversed by the path is illustrated. The shortest path corresponding to link (1,4) in the segment graph is the path 1-2-3-4 in the physical topology. FIG. 4B illustrates the segment graph. FIG. 4C illustrates a 2-hop overlapping path with a flow of 5. Because all these links have a capacity of 10, the value of c̅(q)=10 for link q=(1,4) in the segment graph. Similarly, the link q=(4,8) in the segment graph, corresponds to the path 4-5-2-3-6-8 in the physical topology and each link has a capacity 10. If the path 1-4-8 is used in the segment graph to route from source node 1 to destination node 8, note that link (2,3) in the physical topology is traversed twice. Therefore, the widest connection that can be routed on this path is 5. This fact cannot be deduced from the segment graph alone. A link in the physical topology may be traversed multiple times when constructing the widest path.

FIG. 4D illustrates a 2-hop non-overlapping path with a flow of 10. A path in the segment graph may be called non-overlapping if no link in the physical topology is traversed more than once when a connection is routed on this path. A path in the segment graph will be termed overlapping otherwise.

Therefore a path in the segment graph will be non-overlapping if and only if for any two segments q,r on the path we have SP(q)∩SP(r)=ø. For any non-overlapping path P in the segment graph, the width of the path Ω(P)=min_{q∈P}c̅(q). If the path P is overlapping, then Ω(P)≤min_{q∈P}c̅(q). Thus there exists a non-overlapping widest path between any pair of nodes.

According to embodiments described herein, there may exist a non-overlapping widest path between any two connected nodes in a network, such as any source-destination pair.

The multiplicity μ(q) of a link q in the segment graph may be defined as the number of links in the shortest path in the physical topology corresponding to q as follows:

μ(q)=|SP(q)|.

The multiplicity μ(P) of a path P in the segment graph is the sum of the multiplicity of the links in the path, i.e., μ(P)=Σ_{e∈P}μ(e). The minimum multiplicity widest path is the path between a source and destination is the widest path between the source and destination that has the minimum multiplicity. The minimum multiplicity widest path is non-overlapping.

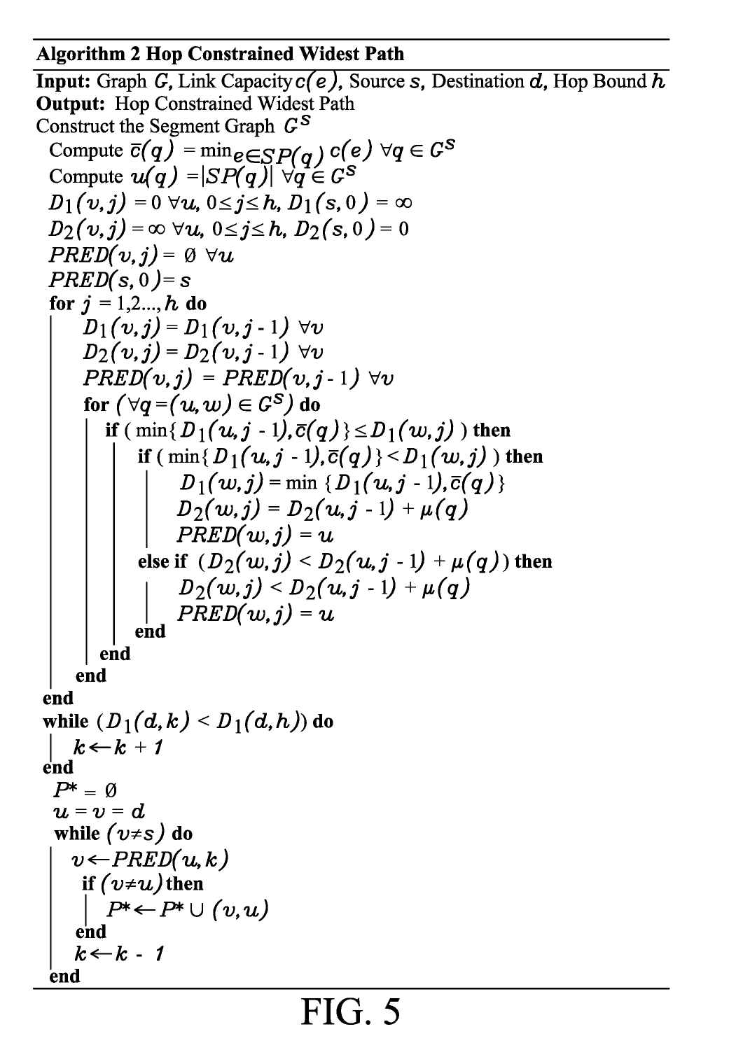

FIG. 5 illustrates an algorithm for the minimum multiplicity widest path. The minimum multiplicity h-hop widest path algorithm between two given nodes s and d has to satisfy the following three conditions:

The path can have at most h hops. The path should be the widest h-hop path. Among all the widest h-hop paths, the algorithm may output one with minimum multiplicity, i.e., the path should use the minimum number of links in the physical layer.

Picking a path with at most h hops can be done using a variant of the Bellman Ford with the widest shortest path algorithm on the segment graph. The capacity of link q, is set to c̅(q). Accounting for overlapping is not straightforward. For example, in FIG. 3, the path 1-4-8 in the segment graph has two links with capacity of 10 each but the actual capacity of the path is only 5, due to the overlap on link (2,3) in the physical topology. The optimal solution is the path 1-3-8 with a capacity of 10. Note that this path is non-overlapping.

To implement the widest path algorithm, at a first step the bandwidth capacity c̅(q) is computed, which may be represented by a segment graph. Then, the multiplicity μ(q) is computed for each link q in the segment graph. The multiplicity μ(q) represents the number of links in the shortest path in the segment graph. In a first loop, D₁(v,j) is a label that represents a maximum capacity of the path having at most j hops from source s to node v in the segment graph, and D₂(v,j) represents a minimum multiplicity corresponding to the maximum capacity path. The second character j represents how many hops have been completed. D₁ and D₂ keep track of how much of the hop h budget is used. PRED (v,0) is the second-to-last vertex on the shortest path (if any) from v to 0. PRED (s,0) is the second-to-last vertex on the shortest path (if any) from s to 0, in this case s.

Beginning with a first, outside, FOR loop, the algorithm iterates through all the links in the segment graph once for each hop limit from 1 to h. At every iteration starting at j=1, the loop determines how many segments have a widest path from s to v not having more than one hop. Then at every iteration starting at j=2, the loop determines how many segments have a widest path from s to v not having more than two hops, until the maximum number of hops is reached.

In the inside FOR loop, the algorithm takes the shortest path from s to v, which has at most h hops. Inside the loop, shortest path from s to v not having more than j hops is equal to the shortest path from node 1 to node v not having more than j−1 hops. When link q=(u,v) is processed for hop j, and min {D₁(u,j−1),c̅(q)} is greater than D₁(v,j) then the algorithm sets D₁(v,j)=min {(D₁ (u,j−1),c̅(q)} and the algorithm updates the corresponding value of D₂(v,j)=D₂(u,j−1)+μ(q). Inside the loop, shortest path from s to v not having more than j hops is equal to the shortest path from node 1 to node v not having more than j−1 hops. In the case where D₁(v,j)=min {D₁(u,j−1),c̅(q)}, the algorithm checks if D₂(v,j)<D₂(u,j−1)+μ(q) and in this case, we set D₂(v,j)=D₂(u,j−1)+μ(q). Inside the loop, every link in the segment graph is considered, and linked. By identifying minimum bandwidth in each link from u from w, the widest path from s to u is found not having more than j−1 hops, and takes the capacity of link (u,w), which is c̅(q). If the capacity of the link is greater than or equal to D1(w,j), then the algorithm is doing the widest path computation, while taking the number of hops into consideration. The last step is necessary to ensure that if there are ties in the maximum capacity path, we break the ties in favor of the minimum multiplicity path. A tie is broken in favor of the path with the shortest number of links to make sure a path is not being used twice.

Thus the widest path to node u using j−1 hops and the capacity of the link from u to u, if a minimum of that relationship is greater than the value at the jth hop between s and u, then that is no longer the path, the new path is wider, and the new path replaces the former path. If there is a tie, the algorithm breaks the tie in favor of the path having a fewer number of links in the segment graph. The tiebreaker is represented by the “else if” event. If it is greater than, then the algorithm sets the D1 value to D2. D1 keeps track of the widest bandwidth. D2 keeps track of the number of links. Adding the current number of links, the algorithm indicates how many links are associated with the widest bandwidth. Thus the algorithm finds the widest path having the minimum number of underlying links.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

1. A method of determining a maximum flow network path between a source node and a destination node using segment routing when constrained by a maximum number of hops, the method comprising:
establishing a segment graph;
calculating the bandwidth capacity of each link in the segment graph;
calculating the multiplicity for each link in the segment graph;
initializing a predecessor array indicating the predecessor node for each node and hop value;
for each link in the segment graph and for each hop value up to the maximum number of hops:
determining the maximum bandwidth path to the end of each segment and the associated number of hops based upon the bandwidth capacity;
updating a value of the predecessor array when the maximum bandwidth path to the end of segment is determined; and
determining the maximum flow network path based upon the predecessor array.

2. The method of claim 1, wherein updating the value of the predecessor array includes choosing the path with the fewest links when two different paths to the end of the segment have the same maximum bandwidth.

3. The method of claim 1, wherein the maximum bandwidth value D₁(v,j) for each value of j is initialized to D₁(v,j−1), where v is an index indicating nodes in the network and j is an index indicating a hop value from 1 to h, where h is the maximum hop value.

4. The method of claim 1, wherein the number of links value D₂(v,j) for each value of j is initialized to D₂(v,j−1), where v is an index indicating nodes in the network and j is an index indicating a hop value from 1 to h, where h is the maximum hop value.

5. The method of claim 1, wherein determining the maximum bandwidth path to the end of each segment and the associated number of hops include determining when min {D₁(u,j−1),c̅(q)}≥D₁(u,j), where D₁(u,j) is a maximum bandwidth value, u is an index indicating the node at the beginning of a link q,j is an index indicating a hop value from 1 to h, h is the maximum hop value, q indicates a link between two nodes, and c̅(q) is the bandwidth capacity bandwidth of the link q.

6. The method of claim 5, further comprising setting D₁(v,j)=min {D₁(u,j−1),c̅(q)}, setting D₂(v,j)=D₂(u,j−1)+μ(q), and setting PRED(v,j)=u, when min {D₁(u,j−1),c̅(q)}>D₁(u,j), where v is an index indicating the node at the end of a link q, μ(q) is the multiplicity of link q, and PRED(v,j) is the predecessor array.

7. The method of claim 5, further comprising setting D₂(v,j)=D₂(u,j−1)+μ(q) and setting PRED(v,j)=u, when min {D₁(u,j−1), c̅(q)}=D₁(u,j) and D₂(v,j)<D₂(u,j−1)+μ(q), where v is an index indicating the node at the end of a link q, μ(q) is the multiplicity of link q, and PRED(v,j) is the predecessor array.

8. The method of claim 5, further comprising:
setting D₁(v,j)=min {D₁(u,j−1),c̅(q)}, setting D₂(v,j)=D₂(u,j−1)+μ(q), and setting PRED(v,j)=u, when min {D₁(u,j−1),c̅(q)}>D₁(u,j); and
setting D₂(v,j)=D₂(u,j−1)+μ(q) and setting PRED(v,j)=u, when min {D₁(u,j−1),c̅(q)}=D₁(u,j) and D₂(v,j)<D₂(u,j−1)+μ(q),
where v is an index indicating the node at the end of a link q, μ(q) is the multiplicity of link q, and PRED(v,j) is the predecessor array.

9. A non-transitory computer readable medium comprising program instructions for causing a computer processor to perform a method of determining a maximum flow network path between a source node and a destination node using segment routing when constrained by a maximum number of hops, the machine-readable storage medium comprising:
instructions for establishing a segment graph;
instructions for calculating the bandwidth capacity of each link in the segment graph;
instructions for calculating the multiplicity for each link in the segment graph;
instructions for initializing a predecessor array indicating the predecessor node for each node and hop value;
instructions for each link in the segment graph and for each hop value up to the maximum number of hops:
instructions for determining the maximum bandwidth path to the end of each segment and the associated number of hops based upon the bandwidth capacity;
instructions for updating a value of the predecessor array when the maximum bandwidth path to the end of segment is determined; and
instructions for determining the maximum flow network path based upon the predecessor array.

10. The non-transitory machine-readable storage medium of claim 9, wherein updating the value of the predecessor array includes choosing the path with the fewest links when two different paths to the end of the segment have the same maximum bandwidth.

11. The non-transitory machine-readable storage medium of claim 9, wherein the maximum bandwidth value D₁(v,j) for each value of j is initialized to D₁(v,j−1), where v is an index indicating nodes in the network and j is an index indicating a hop value from 1 to h, where h is the maximum hop value.

12. The non-transitory machine-readable storage medium of claim 9, wherein the number of links value D₂(v,j) for each value of j is initialized to D₂(v,j−1), where v is an index indicating nodes in the network and j is an index indicating a hop value from 1 to h, where h is the maximum hop value.

13. The non-transitory machine-readable storage medium of claim 9, wherein determining the maximum bandwidth path to the end of each segment and the associated number of hops include determining when min {D₁(u,j−1),c̅(q)}≥D₁(u,j), where D₁(u,j) is a maximum bandwidth value, u is an index indicating the node at the beginning of a link q,j is an index indicating a hop value from 1 to h, h is the maximum hop value, q indicates a link between two nodes, and c̅(q) is the bandwidth capacity bandwidth of the link q.

14. The non-transitory machine-readable storage medium of claim 13, further comprising instructions for setting D₁(v,j)=min{D₁(u,j−1),c̅(q)}, setting D₂(v,j)=D₂(u,j−1)+μ(q), and setting PRED(v,j)=u, when min {D₁(u,j−1),c̅(q)}>D₁(u,j), where v is an index indicating the node at the end of a link q, μ(q) is the multiplicity of link q, and PRED(v,j) is the predecessor array.

15. The non-transitory machine-readable storage medium of claim 13, further comprising instructions for setting D₂(v,j)=D₂(u,j−1)+μ(q) and setting PRED(v,j)=u, when min {D₁(u,j−1),c̅(q)}=D(u,j) and D₂(v,j)<D₂(u,j−1)+μ(q), where v is an index indicating the node at the end of a link q, μ(q) is the multiplicity of link q, and PRED(v,j) is the predecessor array.

16. The non-transitory machine-readable storage medium of claim 13, further comprising:
instructions for setting D₁(v,j)=min {D₁(u,j−1),c̅(q)}, instructions for setting D₂(v,j)=D₂(u,j−1)+μ(q), and setting PRED(v,j)=u, when min {D₁(u,j−1),c̅(q)}>D₁(u,j); and
instructions for setting D₂(v,j)=D₂(u,j−1)+μ(q) and instructions for setting PRED(v,j)=u, when min {D₁(u,j−1),c̅(q)}=D₁(u,j) and D₂(v,j)<D₂(u,j−1)+μ(q),
where v is an index indicating the node at the end of a link q, μ(q) is the multiplicity of link q, and PRED(v,j) is the predecessor array.
